(19) United States
(12) Patent Application Publication
(10) Pub. No.: US 2025/0072649 A1
(43) Pub. Date: Mar. 6, 2025

(54) French Press Apparatus

(71) Applicants: Natalie Kim, Huntington Beach, CA (US); Ernest Kim, Huntington Beach, CA (US)

(72) Inventors: Natalie Kim, Huntington Beach, CA (US); Ernest Kim, Huntington Beach, CA (US)

(21) Appl. No.: 18/526,970

(22) Filed: Dec. 1, 2023

Related U.S. Application Data
(60) Provisional application No. 63/628,917, filed on Sep. 5, 2023.

(51) Int. Cl. A47J 31/38; A47J 31/20

(52) U.S. Cl. CPC A47J 31/38; A47J 31/20

(57) ABSTRACT

An improved brewing apparatus for producing a French press beverage includes a container for a beverage material and a brewing liquid, which has a sloped base extending inwardly from an upper point on its sidewall to a lower point on its bottom wall. The brewing apparatus also includes a plunger assembly coupled to its lid that has a rod and a separation mechanism. A downward force on the rod advances the separation mechanism for separating the beverage material from the brewing liquid to produce the beverage. The brewing apparatus further includes a spout for pouring the beverage from the container that has a bottom end connected to the container generally above and near the upper point of the sloped base. The brewing apparatus also includes a stopper mechanism removably coupled to the spout tip for generally sealing the spout from the beverage material and the brewing liquid entering the spout.

### CROSS-REFERENCE TO RELATED APPLICATIONS

This application claims priority from U.S. Provisional Application No. 63/628,917 filed Sep. 5, 2023, which is herein incorporated by reference.

### FIELD OF THE INVENTION

This invention relates generally to the brewing of liquids, such as coffee, tea, and other beverages, and in particular, to a brewing apparatus for producing a French press beverage and a method for operating a brewing apparatus to produce a French press beverage.

### BACKGROUND OF THE INVENTION

A popular way to prepare coffee is to use a French coffee press to immerse coffee grinds in hot water. The traditional French coffee press comprises a cylindrical container for holding a liquid, a plunger assembly with a rod and a mesh filter, and a lid. The primary component of the apparatus is a cylindrical container that is open at the top end. The container is designed to hold both the coffee grounds and the water during the immersion process. Positioned within the cylindrical container is a plunger assembly. This assembly includes a vertical rod attached at its lower end to a circular mesh filter. The mesh filter is designed to move vertically within the cylindrical container and is of a diameter slightly smaller than the container's inner diameter to allow for smooth movement while preventing coffee grounds from escaping around its periphery. The upper end of the vertical rod extends through the lid and is attached to a handle, allowing the user to manually move the mesh filter up and down within the container.

The apparatus is also equipped with a lid that fits snugly onto the top of the cylindrical container. The lid has an aperture through which the vertical rod of the plunger assembly extends. The lid serves to prevent heat loss during the brewing process and to guide the vertical motion of the plunger assembly. The usual method of use involves the immersion of coffee grounds in water followed by a separation process using the plunger assembly. The user applies a downward force on the handle of the plunger assembly, causing the mesh filter to descend within the cylindrical container. As the mesh filter moves downward, it segregates the wet coffee grounds from the liquid. Once the plunger assembly reaches the base of the cylindrical container, the separation process is complete. The wet coffee grounds remain trapped at the bottom, beneath the mesh filter, and the brewed coffee is poured out of the top of the container.

However, the downside of the traditional French press maker is that unwanted oils and foam are the first elements poured out into a cup of coffee. Since a traditional French press maker pours coffee from the top of the liquid container, coffee oil that floats on the surface of the brewed coffee is poured from the container into the cup that will be consumed by the drinker. Studies have shown that oil from the coffee could increase the drinker's cholesterol levels and harm the drinker's health. Foam also floats on the surface of the brewed coffee. Foam that is generated from the coffee grounds mixing with liquid is bitter to consume. Because of the detrimental effects of consuming coffee oil and the unpleasant taste from drinking the foam, an improved French press coffee maker is needed.

### BRIEF SUMMARY OF THE INVENTION

To mitigate the detrimental effects of consuming coffee oil and the unpleasant taste from drinking foam floating on the surface of brewed coffee, one of the objectives of the present invention is to provide an improved French press. In embodiments of the present invention, a brewing apparatus for producing a French press beverage includes a container for receiving a beverage material and a brewing liquid. The container has sidewalls, a bottom wall, and an open top, and further has a sloped base extending inwardly from an upper point on the sidewall to a lower point on the bottom wall. The brewing apparatus also includes a lid received into the open top of the container and a plunger assembly coupled to the lid and having a rod and a separation mechanism. A user applies a downward force on the rod to advance the separation mechanism downward in the container for separating the beverage material from the brewing liquid to produce the French press beverage. The brewing apparatus further includes a spout for pouring the beverage out of the container, the spout having a tip and a bottom end. The bottom end of the spout is connected to the container generally above and near the upper point of the sloped base. The brewing apparatus also includes a stopper mechanism removably coupled to the spout tip. When the stopper mechanism is coupled to the spout tip, the spout is generally sealed from the beverage material and the brewing liquid entering the spout while the beverage material and the brewing liquid are poured into the container and while the plunger assembly is used to separate the beverage material from the brewing liquid to produce the beverage. When the stopper mechanism is removed from the spout tip, the beverage is pourable out of the spout tip of the container. In this brewing apparatus, because the beverage is pourable out of the spout connected to the container generally near the bottom, rather than the top, of the container, the beverage is generally free from the oils and bitter-tasting foam typically floating on a top surface of the beverage.

In particular embodiments of the present invention, the brewing apparatus further includes a filtering mechanism generally adjacent to the spout tip for filtering the beverage material from the brewing liquid while the beverage is poured out of the spout. In other embodiments, the brewing apparatus also includes a hollow cylinder removably coupled to the spout adjacent the spout tip, where the stopper mechanism is adapted to be removably inserted into the hollow cylinder.

In some embodiments, the brewing apparatus also includes a housing coupled to the container and adapted to fit the sloped base for stabilizing the container on a flat surface. The housing may include a handle for lifting the container. In other embodiments, the brewing apparatus may further include a flat tool apparatus having a clamping region for securing the flat tool apparatus to the container, where the flat tool can be used to cover the bottom end of the spout. The flat tool may include a filter passthrough covering the bottom end of the spout for preventing the beverage material from entering the spout. Alternatively, the brewing apparatus may include a lifter tool apparatus for holding and lifting the beverage material out of the container. The lifter tool may also include a filter passthrough covering the bottom end of the spout for preventing the beverage material from entering the spout.

In another embodiment of the present invention, a method for operating a brewing apparatus to produce a French press beverage is provided. The method may include the step of providing a container having sidewalls, a bottom wall, and an open top, The container has a sloped base extending inwardly from an upper point on the sidewall to a lower point on the bottom wall. The container also has a spout for pouring the beverage out of the container, the spout having a tip and a bottom end, where the bottom end of the spout is connected to the container generally above and near the upper point of the sloped base. The method additionally includes the steps of coupling a removable stopper mechanism to the spout tip, and adding a beverage material and a brewing liquid into the container, where the stopper mechanism generally seals the spout from the beverage material and the brewing liquid entering the spout. The method further includes the steps of placing a lid into the open top of the container, and applying a downward force on a plunger assembly coupled to the lid for separating the beverage material from the brewing liquid to produce the French press beverage, where the stopper mechanism generally seals the spout from the beverage material and the brewing liquid entering the spout. The method includes the additional step of removing the stopper mechanism from the spout tip for pouring the beverage out of the spout tip.

Other features and advantages of the invention will become apparent from the following detailed description, taken in conjunction with the accompanying drawings that illustrate, by way of example, various features of embodiments of the invention.

### BRIEF DESCRIPTION OF THE DRAWINGS

A detailed description of embodiments of the invention will be made with reference to the accompanying drawings, wherein like numerals designate corresponding parts in the several figures.

FIG. 1 is an exploded perspective view of a coffee press in accordance with an embodiment of the present invention.

FIG. 2 is an exploded view of parts of the coffee press shown in FIG. 1 in accordance with an embodiment of the present invention.

FIG. 3a is a cross-sectional view of a coffee press in accordance with an embodiment of the present invention.

FIG. 3b is an enlarged cross-sectional view of parts of the coffee press denoted by the label “B” shown in FIG. 3a in accordance with an embodiment of the present invention.

FIG. 4a is an exploded perspective view of a coffee press with a flat tool apparatus in accordance with another embodiment of the present invention.

FIG. 4b is a side view of the flat tool apparatus that can be used with the coffee press shown in FIG. 4a.

FIG. 4c is a front view of the flat tool apparatus that can be used with the coffee press shown in FIG. 4a.

FIG. 5a is an exploded perspective view of a coffee press in accordance with yet another embodiment of the present invention.

FIG. 5b is an exploded perspective view of the coffee press shown in FIG. 5a in accordance with an embodiment of the present invention.

FIG. 5c is a side view of the coffee press shown in FIGS. 5a and 5b in accordance with an embodiment of the present invention.

### DETAILED DESCRIPTION OF THE INVENTION

As shown in the drawings for purposes of illustration, the invention is embodied in an improved French coffee press. While commonly associated with coffee brewing, this invention is versatile and can accommodate a variety of substances, including tea leaves and other infusible materials, to produce a wide range of infused beverages. The coffee press is referenced in this application for ease of explanation, but this reference should not be construed to limit the scope of this invention. In other embodiments, this invention could be used for various bottled liquids that may contain sediments or particles, including coffees, teas, wines, juices, and sauces.

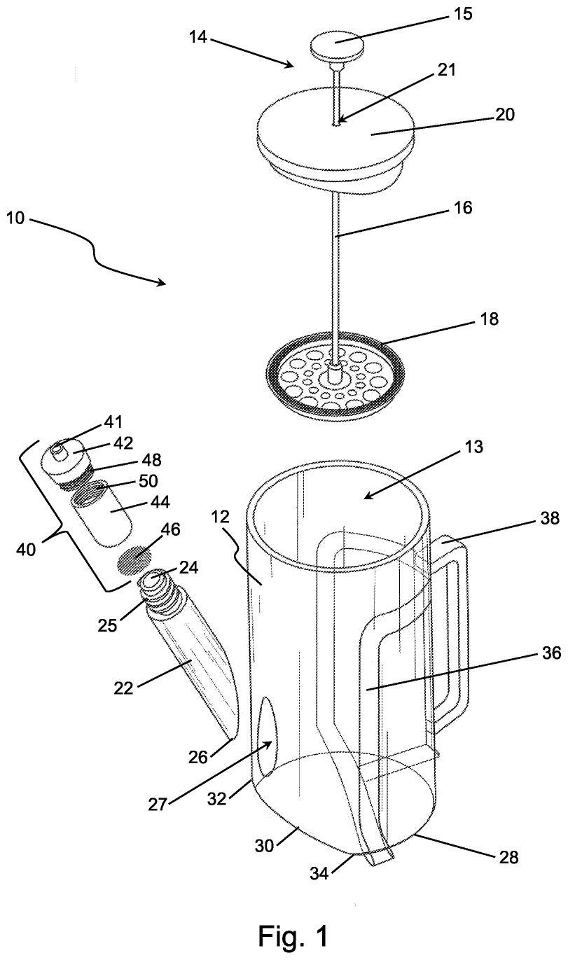

In the embodiment illustrated in FIG. 1, the French press brewing apparatus 10 includes a container 12, typically made of glass, for holding and immersing a beverage material, such as coffee grounds or tea leaves, in a brewing liquid, such as water. The container 12 is generally cylindrical, and has an opening 13 at the top of the container 12, and has sidewalls and a bottom wall 28. The brewing apparatus 10 also includes a lid 20, a combined stopper and filtering mechanism 40 that can be securely fitted to a tip 24 of a spout 22 connected to the container 12, and a plunger assembly 14 with a rod 16 and a separation mechanism 18, such as a mesh, screen, net, or other semi-permeable barrier. The lid 20 fits snugly onto the top of the container 12, and has an aperture 21 through which the rod 16 of the plunger assembly 14 extends and is attached to a handle 15, allowing the user to manually move the separation mechanism 18 up and down within the container 12. The lid 20 serves to prevent heat loss during the brewing process and to guide the vertical motion of the plunger assembly 14. The separation mechanism 18 is designed to move vertically within the container 12 and is of a diameter slightly smaller than an inner diameter of the container 12 to allow for smooth movement while preventing the beverage material, such as coffee grounds, from escaping around its periphery.

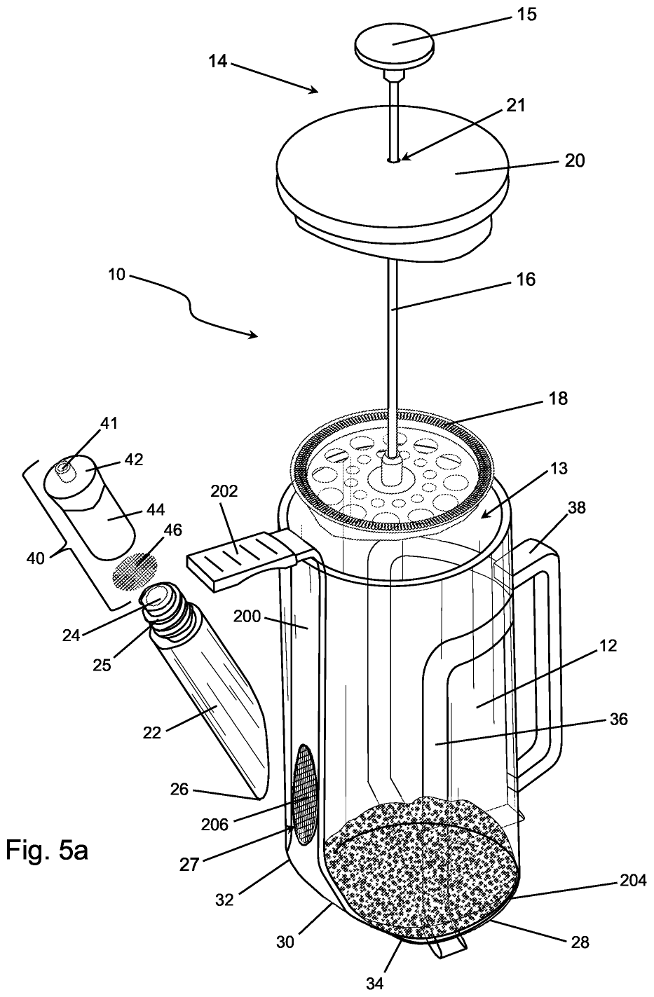

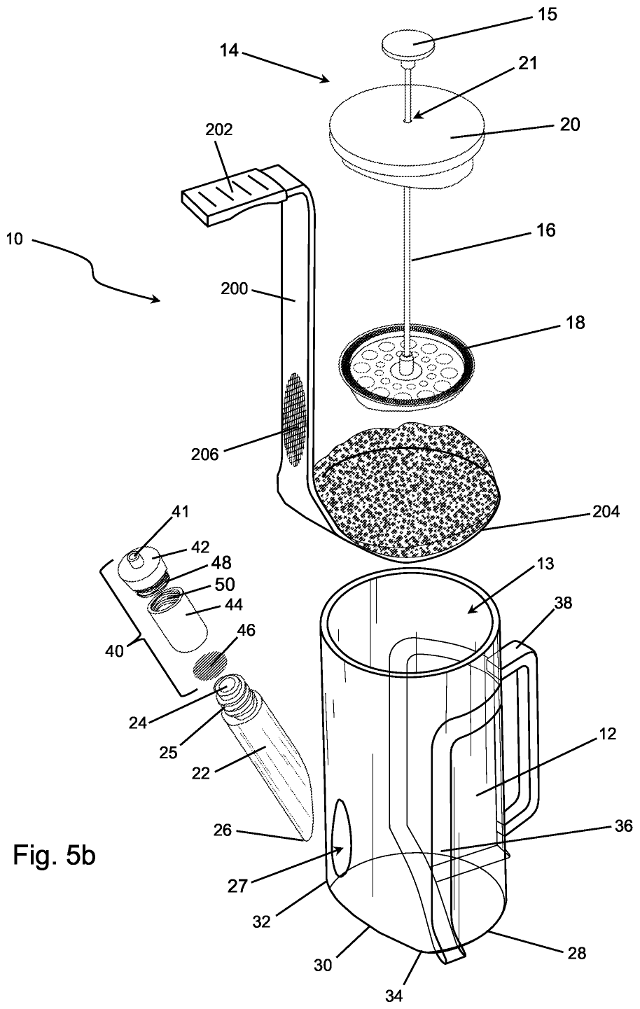

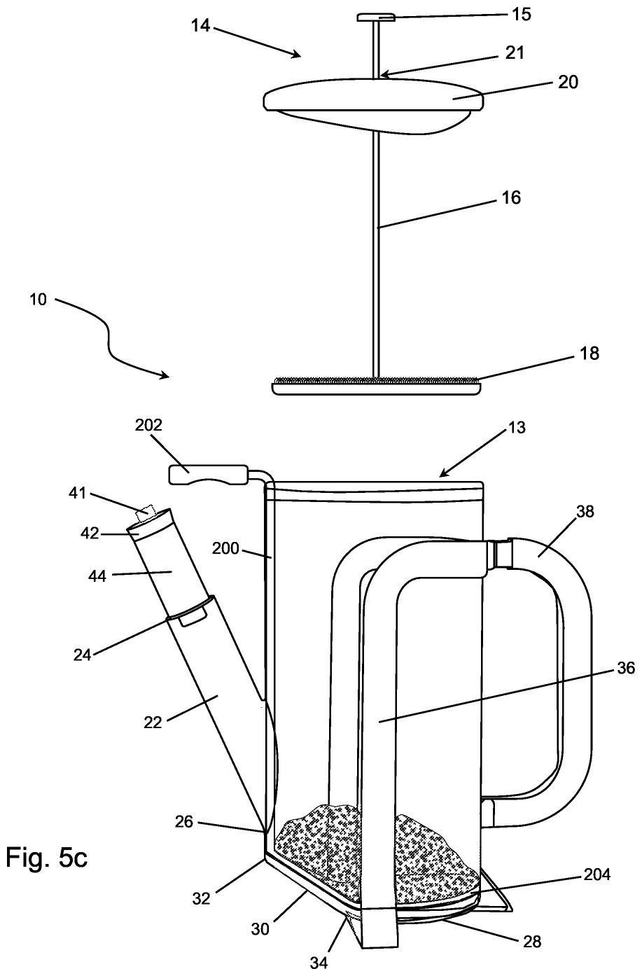

The container 12 has a pour spout 22 with a tip 24 and a bottom end 26 connected to a sidewall of the container 12 near a sloped base 30 of the container 12. The base 30 of the container 12 is sloped so that one end 32 of the base 30 is higher than the other end 34 of the base 30. The base or bottom end 26 of the spout 22 is connected to the sidewall of the container 12 located at or near the highest point 32 of the sloped base 30 on the sidewall, and the lowest point 34 of the sloped base 30 connects to the bottom wall 28 of the container 12. As shown in the illustrated embodiment, the sloped base 30 extends inwardly from its upper or highest point 32 on the sidewall of the container 12 to its lower or lowest point 34 connected to the bottom wall 28 of the container 12, and the bottom end 26 of the spout 22 is connected to the sidewall of the container 12 slightly above the upper point 32 of the sloped base 30. Another example of the sloped base 30 can be seen in the embodiment illustrated in FIG. 5c. In alternative embodiments, the sloped base may extend along an entire bottom of the container 12 and the bottom wall 28 may be omitted; and to form a stable base, the sidewall of the container 12 may extend downward to be flush with the lower point 34 of the sloped base (not shown).

Referring again to the embodiment shown in FIG. 1, since the base 30 is not flat, the container 12 will tilt when placed on a flat surface. To prevent this tilting, the container 12 can rest on a housing 36 fitted for the base 30 of the container 12, for example, with legs, prongs, or other elevating structures that will elevate one side of the container 12 to be flush with the other side of the base 30 or the bottom wall 28, allowing the container 12 to sit vertically straight up on a flat surface with the sidewalls of the container 12 perpendicular to the flat surface. The housing 36 may also include a handle 38 for holding the container 12. In alternative embodiments, the container may include sidewalls that extend down past the sloped base and allow the container to sit vertically straight up on a flat surface without a housing (not shown).

The purpose of the sloped base 30 is to have the beverage material, such as coffee grounds, float to and settle at or near the lower point 34 of the sloped base 30, opposite from the pour spout 22, so that the grounds do not end up blocking the opening 27 to the spout 22. As the coffee grounds settle or are pushed down by the plunging assembly 14, the grounds rest at or near the lower point 34 of the sloped base 30, which is at the opposite side of the upper point 32 of the base 30 nearby where the pour spout 22 is located, so as to avoid the coffee grounds from clogging or blocking the spout 22. The sloped base 30 also facilitates flow of the brewed coffee beverage to the spout 22. Without the sloped base 30, the sidewall of the container 12 would be generally perpendicular to the bottom wall 28 of the container, causing the brewed coffee beverage to pool below the spout 22, and thus, requiring the container 12 to be further tilted in order to pour the brewed coffee beverage out of the spout 22. In various embodiments, the sloped base 30 can level off and can grow flatter or flatten as it extends closer to the lower point 34 of the base 30 in order to better catch and trap the beverage material or sediment away from the opening 27 to the spout 22.

Positioned within the liquid container 12 is the plunger assembly 14. This assembly 14 includes the separation mechanism 18 that moves perpendicular to the sidewalls of the container 12 when the user pushes with a downward force on the rod 16. This means that the direction of movement is at a right angle to the vertical sidewalls of the container 12. The plunger assembly 14 is moving straight down, crossing through the opening 13 of the container 12.

The method of use involves the immersion of the beverage material, such as coffee grounds, in the brewing liquid, such as water, followed by a separation process using the plunger assembly 14. The user applies a downward force on the handle 15 of the plunger assembly 14, causing the separation mechanism 18 to descend within the container 12. As the separation mechanism 18 moves downward, it segregates the wet coffee grounds from the liquid. Once the plunger assembly 14 reaches the bottom of the container 12, the separation process is complete. The wet coffee grounds remain trapped at the bottom, beneath the separation mechanism 18, and the brewed coffee beverage is poured out of the container 12. Because the spout 22 is connected to the container 12 near the bottom, rather than the top, of the container 12, the beverage poured out of the spout 22 is generally free from the oils and bitter-tasting foam typically floating near the top surface of the brewed beverage.

The location of the spout 22 near the sloped base 30 of the container 12 and the pressing downward of the plunging assembly 14 may cause part of the liquid to enter the spout 22 before the beverage material or sediment in the liquid has been fully separated out. In embodiments of the present invention, to prevent too much liquid with sediment from collecting into the spout 22, a separate stopper that is fitted to the tip 24 of the spout 22 may be attached or screwed onto the tip 24 (not shown). The stopper may be cylindrical or conical, and made of silicone, rubber, or other suitable elastomeric material known for its sealing properties. When coupled to the tip 24 of the spout 22, the stopper creates an airtight seal, preventing air from entering or escaping. By limiting the entry of air, the upward migration of the liquid into the spout 22 is hindered, thus reducing the amount of unfiltered liquid entering the spout 22. As a result, when the user completes the plunging action of the plunger assembly 14 and is pouring out the beverage, minimal beverage material or sediment is mixed in, resulting in a more thorough separation process. Once separation is achieved through use of the plunger assembly 14, the user can remove the stopper and pour out the beverage, which is now significantly free from the beverage material or sediment as the separation mechanism 18 of the plunger assembly 14 has trapped the sediment at the lower part 34 of the sloped base 30. In one embodiment, a separate filter shaped to snugly fit the interior or exterior of the tip of the spout, and made of mesh, screen, or other semi-permeable material may also be attached or screwed onto the tip 24 of the spout 22 (not shown). This filter can serve to further remove sediment from the beverage that is poured out of the spout 22. In alternative embodiments, the filter may be integrated into the spout 22 (not shown). However, a separate filter provides case of cleaning of both the container 12 including the spout 22 as well as the separate filter.

In the embodiments illustrated in FIGS. 1-3b and 5c, to prevent too much liquid with sediment from collecting into the spout 22, a combined stopper and filtering mechanism 40 that is fitted to the tip 24 of the spout 22 can be attached or screwed onto the tip 24. The combined stopper and filtering mechanism 40 includes a stopper 42 and a hollow cylinder 44. When connected to the hollow cylinder 44, the stopper 42 creates an airtight seal, preventing too much liquid with sediment from collecting into the spout. The stopper 42 may be made of silicone, rubber, or other suitable elastomeric material known for its sealing properties.

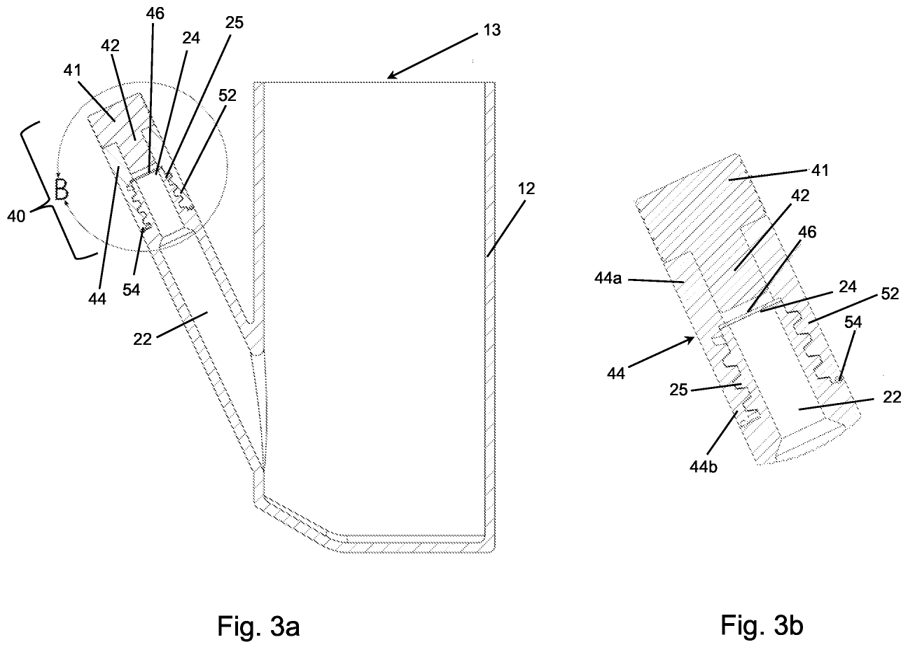

Referring to FIGS. 3a and 3b, the hollow cylinder 44 is configured to attach securely to the spout 22. The cylinder 44 has a top portion 44a and a bottom portion 44b. The bottom portion 44b has interior screw threads 52 that are adapted to securely engage corresponding exterior screw threads 25 located near the tip 24 of the spout 22. To ensure that the cylinder 44 cannot be overtightened, a bottom surface of the cylinder 44 contacts the spout 22 at a scaling point 54. Attached within the interior of the hollow cylinder 44 is a filter 46 that is positioned horizontally so when liquid flows through the hollow cylinder 44, the filter 46 can trap and remove sediment or particles from the brewed beverage or liquid while being poured out of the container 12. The filter 46 is positioned within the cylinder 44 to rest atop the tip 24 of the spout 22 and fully cover the tip 24 of the spout 22 when the cylinder 44 is fully engaged with the spout 22.

In the embodiments illustrated in FIGS. 1-3b, the top portion 44a is designed to extend beyond the tip 24 of the spout 22. The top portion 44a of the cylinder 44 provides enough surface area for the stopper 42 to be inserted into the interior of the top portion 44a of the cylinder 44. The stopper 42 is adapted to fit securely into the top portion 44a of the cylinder 44 and create an airtight seal.

When the stopper 42 is attached to the top portion 44a and liquid is poured into the container 12, the stopper 42 creates a temporary air chamber within the spout 22 and forms an airtight seal, preventing too much liquid with beverage material or sediment from collecting into the spout 22. The air chamber effectively prevents the entry of liquid into the spout 22 until the stopper 42 is removed. The design ensures easy attachment and detachment, facilitating convenient usage and cleaning.

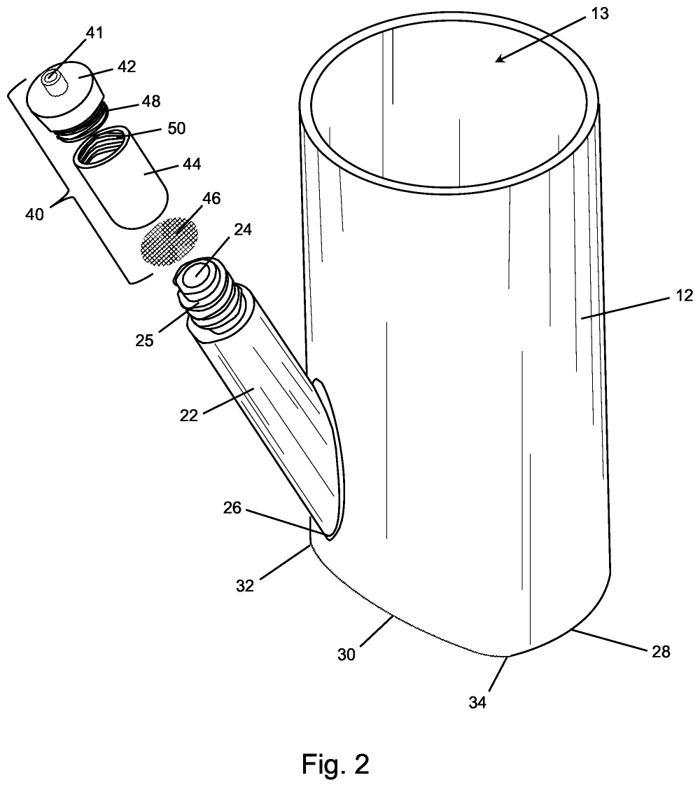

The stopper 42 features a handle 41 or grip that allows users to easily remove the stopper 42 when they pour the brewed beverage or liquid out through the spout 22. When the stopper 42 is removed, the airtight seal is broken, allowing the beverage or liquid to flow through the spout 22 and the hollow cylinder 44 and to pour out of the container 12. Referring to FIGS. 1 and 2, the stopper 42 may have exterior screw threads 48 to engage corresponding interior screw threads 50 on the top portion 44a of the cylinder 44 to ensure that the stopper 24 stays on, particularly during the separation process as the plunger assembly 14 is pressed downward within the container 12. Alternatively, as shown in FIGS. 3a and 3b, the stopper 42 and the top portion 44a of the cylinder 44 may not have screw threads. The stopper 42 may be compact and have a shape contoured to snugly fit within the top portion 44a of the cylinder 44 in order to ensure an airtight seal. In further alternative embodiments, the stopper 42 may have raised annular threads such as a silicone stopper (not shown), which also provide resistance to ensure the airtight seal. The top portion 44a of the cylinder 44 may or may not have threads to engage the corresponding raised annular threads on the stopper 42 (not shown), or alternatively, only the top portion 44a of the cylinder may have raised annular threads to ensure the airtight seal (not shown).

The top portion 44a and the bottom portion 44b of the hollow cylinder 44 may be constructed using food-grade materials, including but not limited to metals such as stainless steel, glass, ceramic, or plastic, ensuring durability, hygiene, and safety for the users. In some embodiments, the top portion 44a and the bottom portion 44b may be made of the same material, such as stainless steel, glass, or ceramic. In other embodiments, the top portion 44a may be made of one material, and the bottom portion 44b may be made of another material. For example, in the event of material expansion due to heat from the liquid, the bottom portion 44b may be made of plastic, which provides more “give” when exposed to heat while connected to the glass screw threads 25 on the container 12. The top portion 44a may be made of stainless steel, ceramic, or glass, and since the top portion 44a is designed to extend past the tip 24 of the spout 22, the brewed beverage does not contact any plastic as it is poured out of the container 12, thus avoiding any plastic leaching into the beverage. The mesh filter 46 is positioned within the cylinder 44 at the point where the plastic bottom portion 44b and metal/glass/ceramic top portion 44a connect.

In alternative embodiments, the combined stopper and filtering mechanism may include a filtering mechanism attached to the bottom or base of the stopper (not shown). The filtering mechanism may be in the shape of a cylinder with filtering holes, slits, or other perforations along the sidewalls of the cylinder. The stopper may be attached at the top of the filtering cylinder, with the bottom open end of the filtering cylinder protruding into the tip of the spout. The sidewalls of the filtering cylinder fit snugly along the interior of the spout adjacent the tip. The filtering cylinder may be made of metal, ceramic, glass, or other resilient material, and may have a sealing gasket or a rubber seal that serves as a barrier to prevent any liquid from leaking out the exterior sides of the filtering cylinder and also helps the filtering cylinder stay in place within the spout. As the brewed beverage or liquid is poured out of the spout, the beverage or liquid enters the open end of the filtering cylinder and passes through the filtering holes or slits, where additional sediment may be trapped and separated from the beverage or liquid. If a screw thread mechanism is used to attach this combined stopper and filtering mechanism to the tip of the spout, the screw thread mechanism can be designed to be fully engaged (airtight), partially engaged (permitting liquid flow), or fully removed. When the stopper is partially unscrewed but not fully removed from the tip of the spout, the stopper is not fully engaged so the base part of the stopper with the filtering mechanism is still partially inside the spout and provides further filtering of the beverage being poured out of the spout.

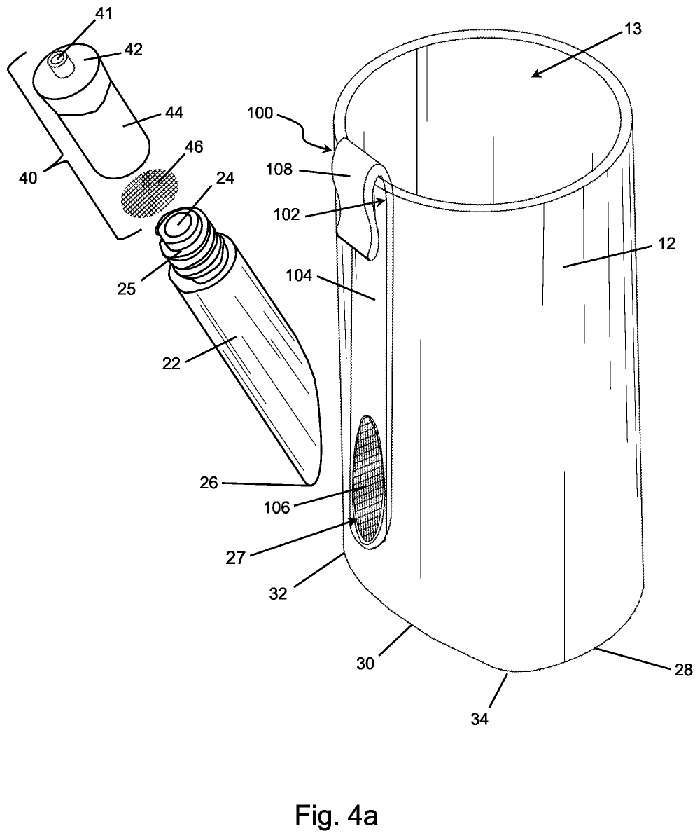

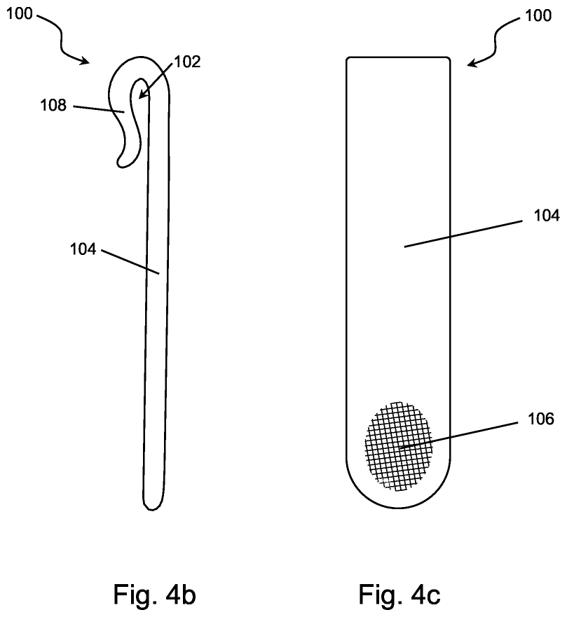

FIGS. 4a-4c illustrate another embodiment of the present invention, in which similar components may have the same reference numerals as previously described with reference to the other Figures. In the illustrated embodiment, the coffee press 10 includes a flat tool apparatus 100 consisting of a resilient, elongated piece of material that is folded or curved back upon itself to create a clamping region 102, similar to a money clip. This clamping region 102 is crafted to exert pressure ensuring that the tool apparatus 100 is held securely in place while facilitating its sliding movement up and down along the sidewalls of the liquid container 12. This clamping region 102 is optimized to grip the sidewalls securely without causing damage. The clamping region 102 allows the tool apparatus 100 to slide up and down the sidewall of the container 12, facilitating positioning at various heights based on user preference or specific utility.

Materials used for this clamping apparatus 100 may include metals, plastics, or composite materials. The purpose of the clamping apparatus 100 is to have one flat side 104 of the apparatus 100 slide along the interior wall of the container 12 and rest at a location that covers up the opening 27 to the spout 22 in order to prevent liquid from entering the spout 22 before being separated from the beverage material or sediment. Accordingly, one side 104 of the apparatus 100 lays flat against the interior sidewall of the container 12 and is long enough to reach and cover up the opening 27 to the spout 22 while the clamping region 102 of the apparatus 100 rests on the lip of the container 12. The apparatus is also wide enough to fully cover up the opening 27 to the spout 22. This portion of the apparatus 100 that covers the opening 27 may be solid, or alternatively may consist of mesh, screen, or other semi-permeable material 106 that can filter out any sediment from entering the spout 22. The other side 108 of the apparatus 100 slides along the exterior wall of the container 12 and helps keep the apparatus 100 attached to the container 12. The container 12 can have grooves or indentations (not shown) that allows the apparatus 100 to be aligned and guided as it slides up and down the interior and exterior sidewalls of the container 12. When the liquid has been filtered so that the beverage material and sediment has been removed, the user can partially lift or fully remove the apparatus 100, thereby unblocking the opening 27 to the spout 22 and allowing the filtered beverage liquid to enter the spout 22. The lid may have a small aperture or gap (not shown) to fit around the clamping region 102 of the apparatus 100 and to allow the user to lift the apparatus 100 through the aperture of the lid in order to unblock the opening 27 to the spout 22 and pour the filtered beverage liquid out of the spout 22. In alternative embodiments, the opening 27 to the spout 22 can have a mesh or screen covering that is permanently affixed to the opening 27 (not shown) in order to prevent any unwanted sediment from entering the spout 22.

In another embodiment, this tool apparatus 100 may have a protrusion or rod extending out of the part 108 of the apparatus 100 located at the exterior sidewall of the container 12 near the clamping region 102, with the end of the protrusion or rod attached to a stopper that is aligned to cover the tip 24 of the spout 22 as previously described (not shown). When the apparatus 100 is slid down the sidewall of the container 12, the stopper protruding from the apparatus 100 automatically covers and can be attached to the tip 24 of the spout 22. Alternatively, a filter mechanism (rather than a stopper) can be attached to the end of the protrusion or rod to cover or be inserted into the tip 24 of the spout 22 for additional filtering of sediment. In this embodiment, since the apparatus 100 is partially lifted so that the apparatus 100 no longer blocks the opening 27 to the spout 22 for pouring, the filter mechanism is attached to a protrusion or rod that can be adjusted, facilitating positioning at various heights so the filter mechanism maintains contact with the tip 24 of the spout 22.

FIGS. 5a-5c illustrate another embodiment of the present invention, in which similar components may have the same reference numerals as previously described with reference to the other Figures. In the illustrated embodiment, the coffee press 10 includes a grounds lifter tool apparatus 200 including a handle 202 for maneuvering the lifter tool 200 and a plate 204 for catching and holding the grounds as the grounds settle to the bottom of the container 12 and/or are pushed down by the plunger assembly 14 during the separation process. Similar to the flat tool apparatus 100, the portion of the grounds lifter tool apparatus 200 that covers the opening 27 to the spout 22 may consist of mesh, screen, or other semi-permeable material 206 that can filter out any beverage material or sediment from entering the spout 22.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A brewing apparatus for producing a French press beverage, comprising:
a container for receiving a beverage material and a brewing liquid, the container having sidewalls, a bottom wall, and an open top, wherein the container has a sloped base extending inwardly from an upper point on the sidewall to a lower point on the bottom wall;
a lid received into the open top of the container;
a plunger assembly coupled to the lid and having a rod and a separation mechanism, wherein a downward force on the rod advances the separation mechanism downward in the container for separating the beverage material from the brewing liquid to produce the French press beverage;
a spout for pouring the beverage out of the container, the spout having a tip and a bottom end, wherein the bottom end of the spout is connected to the container generally above and near the upper point of the sloped base; and
a stopper mechanism removably coupled to the spout tip, wherein when the stopper mechanism is coupled to the spout tip, the spout is generally sealed from the beverage material and the brewing liquid entering the spout while the beverage material and the brewing liquid are poured into the container and while the plunger assembly is used to separate the beverage material from the brewing liquid to produce the beverage, and further wherein when the stopper mechanism is removed from the spout tip, the beverage is pourable out of the spout tip of the container.

2. The brewing apparatus of claim 1, further comprising:
a filtering mechanism generally adjacent to the spout tip for filtering the beverage material from the brewing liquid while the beverage is poured out of the spout.

3. The brewing apparatus of claim 1, further comprising a hollow cylinder removably coupled to the spout adjacent the spout tip, wherein the stopper mechanism is adapted to be removably inserted into the hollow cylinder.

4. The brewing apparatus of claim 3, wherein the hollow cylinder has a top portion and a bottom portion, the stopper mechanism being removably inserted into the top portion, and the bottom portion being removably coupled to the spout adjacent the spout tip, and further wherein the hollow cylinder includes a filtering mechanism for filtering the beverage material from the beverage when the stopper mechanism is removed from the top portion and the beverage is poured out of the spout tip and through the hollow cylinder.

5. The brewing apparatus of claim 4, wherein the spout has external threads adjacent the tip, and the bottom portion has corresponding internal threads for engaging the external threads on the spout.

6. The brewing apparatus of claim 4, wherein the stopper mechanism is shaped for a snug fit within the top portion of the cylinder.

7. The brewing apparatus of claim 4, wherein the top portion has internal threads, and the stopper mechanism has corresponding external threads for engaging the internal threads on the top portion.

8. The brewing apparatus of claim 4, wherein the top portion is made of metal, ceramic, or glass, and the bottom portion is made of metal, ceramic, glass, or plastic.

9. The brewing apparatus of claim 1, further comprising:
a housing coupled to the container and adapted to fit the sloped base for stabilizing the container on a flat surface, wherein the housing includes a handle for lifting the container.

10. The brewing apparatus of claim 1, further comprising:
a flat tool apparatus for covering the bottom end of the spout and sealing the spout from liquid entering the spout while the beverage material and the brewing liquid are poured into the container and while the beverage material is separated from the brewing liquid, wherein the tool apparatus includes a clamping region for securing the flat tool apparatus to the container.

11. The brewing apparatus of claim 1, further comprising:
a flat tool apparatus for covering the bottom end of the spout, wherein the flat tool apparatus includes a clamping region for securing the flat tool apparatus to the container and a filter passthrough covering the bottom end of the spout for preventing the beverage material from entering the spout.

12. The brewing apparatus of claim 1, further comprising:
a lifter tool apparatus having a plate for holding the beverage material adjacent the bottom wall of the container and for lifting the beverage material out of the container after the beverage is produced, the lifter tool apparatus further having a filter passthrough covering the bottom end of the spout for preventing the beverage material from entering the spout.

13. A method for operating a brewing apparatus to produce a French press beverage, comprising:
providing a container having sidewalls, a bottom wall, and an open top, wherein the container has a sloped base extending inwardly from an upper point on the sidewall to a lower point on the bottom wall, and further wherein the container has a spout for pouring the beverage out of the container, the spout having a tip and a bottom end, wherein the bottom end of the spout is connected to the container generally above and near the upper point of the sloped base;
coupling a removable stopper mechanism to the spout tip;
adding a beverage material and a brewing liquid into the container, wherein the stopper mechanism generally seals the spout from the beverage material and the brewing liquid entering the spout;
placing a lid into the open top of the container;
applying a downward force on a plunger assembly coupled to the lid for separating the beverage material from the brewing liquid to produce the French press beverage, wherein the stopper mechanism generally seals the spout from the beverage material and the brewing liquid entering the spout; and
removing the stopper mechanism from the spout tip for pouring the beverage out of the spout tip.

14. The method for operating the brewing apparatus of claim 13, further comprising the step of:
coupling a filtering mechanism generally adjacent to the spout tip for filtering the beverage material from the brewing liquid while the beverage is poured out of the spout.

15. The method for operating the brewing apparatus of claim 14, wherein the step of coupling the filter mechanism further comprises the step of attaching a removable hollow cylinder having a top portion and a bottom portion to the spout adjacent the spout tip, and
wherein the step of coupling the removable stopper mechanism further comprises the step of removably inserting the stopper mechanism into the top portion, and
further wherein the hollow cylinder includes the filtering mechanism adapted to be located on top of the spout tip for filtering the beverage material from the beverage when the stopper mechanism is removed from the top portion and the beverage is poured out of the spout tip.

16. The method for operating the brewing apparatus of claim 15, wherein the stopper mechanism is shaped for a snug fit within the top portion of the cylinder.

17. The method for operating the brewing apparatus of claim 15, wherein the top portion has internal threads, and the stopper mechanism has corresponding external threads for engaging the internal threads on the top portion.

18. The method for operating the brewing apparatus of claim 13, further comprising the step of:
before adding a brewing liquid into the container, securing a flat tool apparatus to the container for covering the bottom end of the spout, wherein the flat tool apparatus includes a clamping region for securing the flat tool apparatus to the container, and
further wherein, during the adding the beverage material and the brewing liquid step and during the applying the downward force step, the flat tool apparatus seals the spout from liquid entering the spout.

19. The method for operating the brewing apparatus of claim 13, further comprising the step of:
before adding a brewing liquid into the container, securing a flat tool apparatus to the container for covering the bottom end of the spout, wherein the flat tool apparatus includes a clamping region for securing the flat tool apparatus to the container, and
further wherein, during the adding the beverage material and the brewing liquid step and during the applying the downward force step, the flat tool apparatus further includes a filter passthrough covering the bottom end of the spout for preventing the beverage material from entering the spout.

20. The method for operating the brewing apparatus of claim 13, further comprising the steps of:
before adding a brewing liquid into the container, placing a lifter tool apparatus adjacent the bottom wall of the container, the lifter tool apparatus having a plate for holding the beverage material adjacent the bottom wall of the container, and
further wherein, during the adding the beverage material and the brewing liquid step and during the applying the downward force step, the lifter tool apparatus further includes a filter passthrough covering the bottom end of the spout for preventing the beverage material from entering the spout; and
lifting the lifter tool apparatus with the beverage material on the plate out of the container after the beverage is produced.
